(19) United States
(12) Patent Application Publication
(10) Pub. No.: US 2017/0314381 A1
(43) Pub. Date: Nov. 2, 2017

(54) CONTROL SYSTEM FOR DETERMINING SENSOR BLOCKAGE FOR A MACHINE

(71) Applicant: Caterpillar Inc., Peoria, IL (US)

(72) Inventors: Nicolas François-Xavier Christophe Vandapel, Pittsburgh, PA (US); Nicholas Chan, Pittsburgh, PA (US); Michael Karl Wilhelm Happold, Fox Chapel, PA (US); Syed Waqas Hassan Tirmizi, Wexford, PA (US)

(73) Assignee: Caterpillar Inc., Peoria, IL (US)

(21) Appl. No.: 15/142,809

(22) Filed: Apr. 29, 2016

(51) Int. Cl. E21B 44/00; G01S 17/02; G01S 15/02; G01S 13/02; G01B 21/00; G05D 1/00; E21B 7/02

(52) U.S. Cl. CPC E21B 44/00; G05D 1/0088; G01S 17/02; E21B 7/022; G01S 13/02; G01B 21/00; G01S 15/02

(57) ABSTRACT

A control system for a machine including a perception system comprising at least one sensor disposed on the machine and generating data signals pertaining to the machine and an environment associated with the machine and a controller communicably coupled to the perception system for receiving the data signals from the at least one sensor and determining from the data signals terrain features associated with the work site and presence of one or more objects on the work site or the machine, determining geometry of the at least one sensor, location of the at least one sensor on the machine, generating a field of view for the at least one sensor, estimating cast shadow for at least one object of the one or more objects based on the geometry and location of the at least one sensor and comparing the field of view with the cast shadow to determine sensor blockage.

### TECHNICAL FIELD

The present disclosure generally relates to a system for controlling operation of a machine. More particularly, the present disclosure relates to a system for determining sensor blockage and blind zones around the machine to control the operation of the machine.

### BACKGROUND

Autonomous machines are designed to perform some or all required functions autonomously (using sensors), i.e., without contemporaneous user input. Several systems and methods have been developed to allow such machines to perform such functions autonomously. However, the systems and methods used to control the autonomous machines are highly dependent on the area of a work site that can be perceived by one or more sensors of the autonomous machine.

The machine's ability to perceive its environment is constrained by the sensors field of view and sensing range, the terrain complexity arising from static and dynamic objects and atmospheric conditions (dust, rain). Accordingly, sections of the terrain might not be visible to the machine. For e.g. the field of view for the sensors may have some missing data (portion of the work site not perceived by the sensor). This missing data may be due to an object proximate to the sensor occluding its field of view. Alternatively, the sensor may not be able to detect an object in the vicinity of the sensor due to harsh environmental conditions. Alternatively, due to the dusty conditions on the work site the sensor may not be able to perceive a portion of the work site.

Since some sections of the work site may not be perceived, it is challenging for a control system of the autonomous machine to determine an appropriate path to follow to perform the desired operations on the work site.

WO 2011085435A1 discloses gathering data about a work site. The data about the work site pertains to the terrain features and objects present on the ground surface of the work site. Based on the data related to the work site, the height of objects or terrain features is determined.

### SUMMARY OF THE DISCLOSURE

In one aspect of the present disclosure, a control system for a machine operating at a work site is disclosed. The control system includes a perception system comprising at least one sensor disposed on the machine and configured to generate data signals pertaining to at least one of the machine and an environment associated with the machine. The control system also includes a controller communicably coupled to the perception system for receiving the data signals from the at least one sensor. The controller is configured to determine from the data signals terrain features associated with the work site and presence of one or more objects on the work site or the machine. The controller is further configured to determine geometry of the at least one sensor, location of the at least one sensor on the machine and generate a field of view for the at least one sensor. The controller is also configured to estimate the cast shadow for at least one object of the one or more objects based on the geometry and location of the at least one sensor and compare the field of view with the cast shadow to determine the sensor blockage for the at least one sensor.

In another aspect of the present disclosure, a machine is disclosed. The machine includes a frame, at least one operational system disposed on the frame, the at least one operational system being configured to actuate at least one type of operation in the machine and a perception system comprising at least one sensor disposed on the machine and configured to generate data signals pertaining to at least one of the machine and an environment associated with the machine. The machine further includes a controller communicably coupled to the perception system for receiving the data signals from the at least one sensor. The controller is configured to determine from the data signals terrain features associated with the work site and presence of one or more objects on the work site or the machine. The controller is further configured to determine geometry of the at least one sensor, location of the at least one sensor on the machine and generate a field of view for the at least one sensor. The controller is also configured to estimate the cast shadow for at least one object of the one or more objects based on the geometry and location of the at least one sensor and compare the field of view with the cast shadow to determine the sensor blockage for the at least one sensor.

In yet another aspect of the present disclosure, a method of controlling operation of a machine at a work site is disclosed. The method includes generating by at least one sensor disposed on the autonomous machine data signals pertaining to at least one of the autonomous machine and an environment associated with the autonomous machine, receiving by a controller communicably coupled to the at least one sensor the data signals, determining from the data signals terrain features associated with the work site and presence of one or more objects on the work site or the autonomous machine, determining geometry of the at least one sensor and location of the at least one sensor on the autonomous machine, generating a field of view for the at least one sensor, estimating the cast shadow for at least one object of the one or more objects based on the geometry and location of the at least one sensor, comparing the field of view with the cast shadow to determine the sensor blockage for the at least one sensor and operating the autonomous machine on the work site based on the sensor blockage

### BRIEF DESCRIPTION OF THE DRAWINGS

FIG. 1 is a diagrammatic illustration of an exemplary machine operating at a work site.

FIG. 2 is a schematic of a control system having a perception system and a controller for controlling operation of the exemplary machine of FIG. 1, in accordance with embodiments of the present disclosure.

FIG. 3 illustrates a portion of the work site having the machine and one or more objects in accordance with an embodiment of the present disclosure.

FIG. 4 illustrates a portion of the work site having the machine and one or more objects in accordance with yet another embodiment of the present disclosure.

FIG. 5 illustrates a field of view for a first sensor in accordance with an embodiment of the present disclosure.

FIG. 6 illustrates estimating a cast shadow by the one or more object for the first sensor and comparing it with the field of view of the first sensor to determine the sensor blockage for the first sensor in accordance with an embodiment of the present disclosure.

FIG. 7 illustrates a field of view for a second sensor in accordance with an embodiment of the present disclosure.

FIG. 8 illustrates estimating a cast shadow by the one or more object for the second sensor and comparing it with the field of view of a second sensor to determine the sensor blockage for the second sensor in accordance with an embodiment of the present disclosure.

FIG. 9 illustrates comparing the field of view for the first sensor and the second sensor to determine the blind zone for the machine.

FIG. 10 illustrates a field of view for a first sensor in accordance with an embodiment of the present disclosure.

FIG. 11 is a flowchart depicting a method of controlling an operation of the exemplary machine in accordance with an embodiment of the present disclosure.

### DETAILED DESCRIPTION

Reference will now be made in detail to the embodiments of the disclosure, examples of which are illustrated in the accompanying drawings. Wherever possible, the same reference number will be used throughout the drawings to refer to the same or like parts.

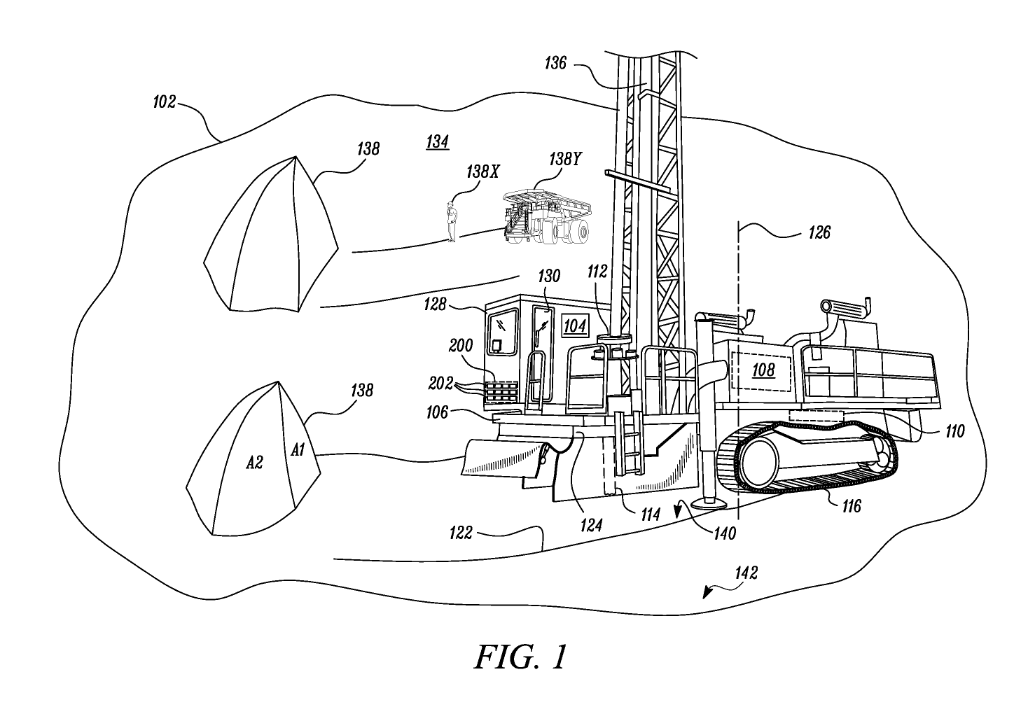

With reference to FIG. 1, an exemplary machine 100 operating at a work site 102 is depicted, in which embodiments of the present disclosure may be implemented. As, shown in FIG. 1, the machine 100 is embodied in the form of a drill. The machine 100 may be used in a variety of applications including mining, quarrying, road construction, construction site preparation, etc. For example, the drill of the present disclosure may be employed for penetrating earth materials such as ore, soil, debris, or other naturally occurring deposits from the work site 102; and for defining one or more openings (not shown) in such earth materials.

Although the exemplary machine 100 is embodied as a drill in the illustrated embodiment of FIG. 1, it will be appreciated that the other types of machines including, but not limited to, diggers, hydraulic excavators, motor graders, and the like can be optionally used in lieu of the drill disclosed herein to implement the embodiments of the present disclosure. Moreover, for purposes of the present disclosure, the machine 100 may be regarded as an autonomous drilling machine. Although an autonomous drilling machine is contemplated, various other drilling machines known in the art with various level of autonomy, such as a manually operated drilling machine, semiautonomous drilling machine, remotely operated drilling machine, or remotely supervised drilling machine, would also apply. Therefore, notwithstanding any particular configuration of the machine 100 disclosed in this document, it may be noted that embodiments disclosed herein can be similarly applied to other types of machines without deviating from the spirit of the present disclosure.

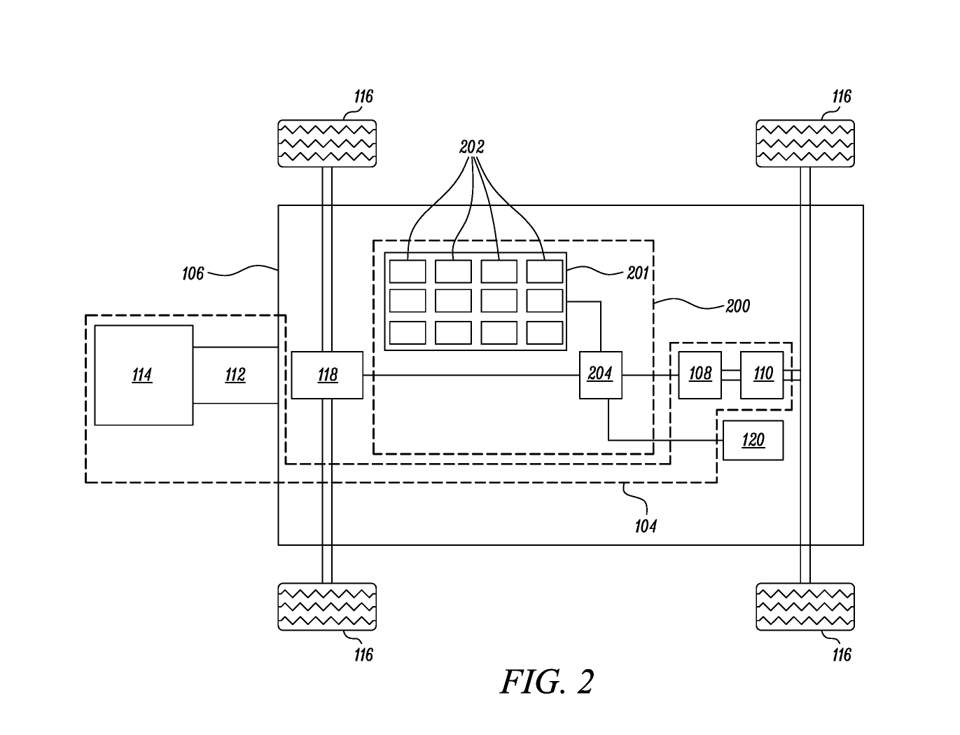

Referring to FIGS. 1, 3 and 4, the machine 100 may include a frame 106 for supporting thereon at least one operational system 104 of the machine 100 and multiple ground engaging members 116 for e.g., tracks as shown in FIG. 1 or wheels as shown in FIG. 2. The at least one operational system 104 is configured to actuate a particular mode of operation for the machine 100 to perform a desired operation on the work site 102. With regards to the exemplary machine 100 of FIG. 1, the machine 100 may have a plurality of modes of operation. In the embodiment illustrated, the machine 100 would typically include a tramming mode, a jacking mode, a drilling mode, an articulating mode, and an idle state, but is not limited thereto. Although five operating modes are disclosed herein, the number of operating modes may vary depending on the type of the machine 100, the configuration of operational systems present in the machine 100, and also based on the functions needed to be performed by the machine 100.

As shown in FIG. 2, the at least one operational system 104 disclosed herein could include a drive system 108, a transmission system 110, an articulation system 112, and a work implement 114 for e.g., a drilling tool. The drive system 108 may include an engine (not shown), an electric motor for e.g., a traction motor (not shown), or both depending on specific requirements of an application. The transmission system 110 may include gears, differential systems, axles, and other components (not shown) that are coupled to the drive system 108 and the ground engaging members 116 of the machine 100. The transmission system 110 is configured to transfer power from the drive system 108 to the ground engaging members 116 and hence, propel the machine 100 on a work surface 122 of the work site 102 (as shown in FIG. 1).

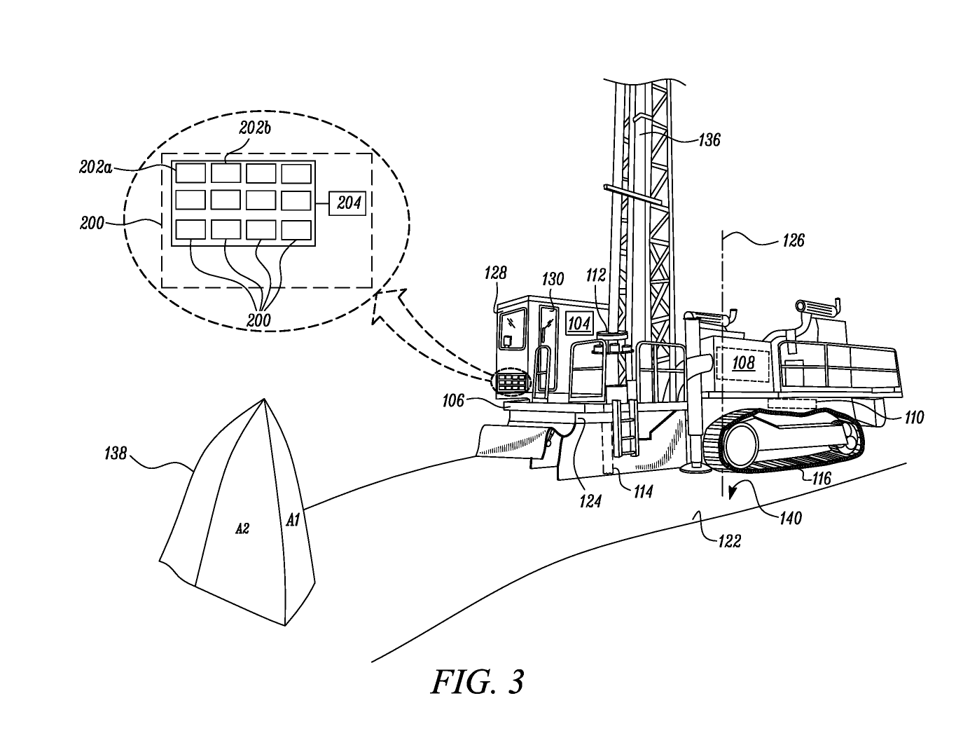

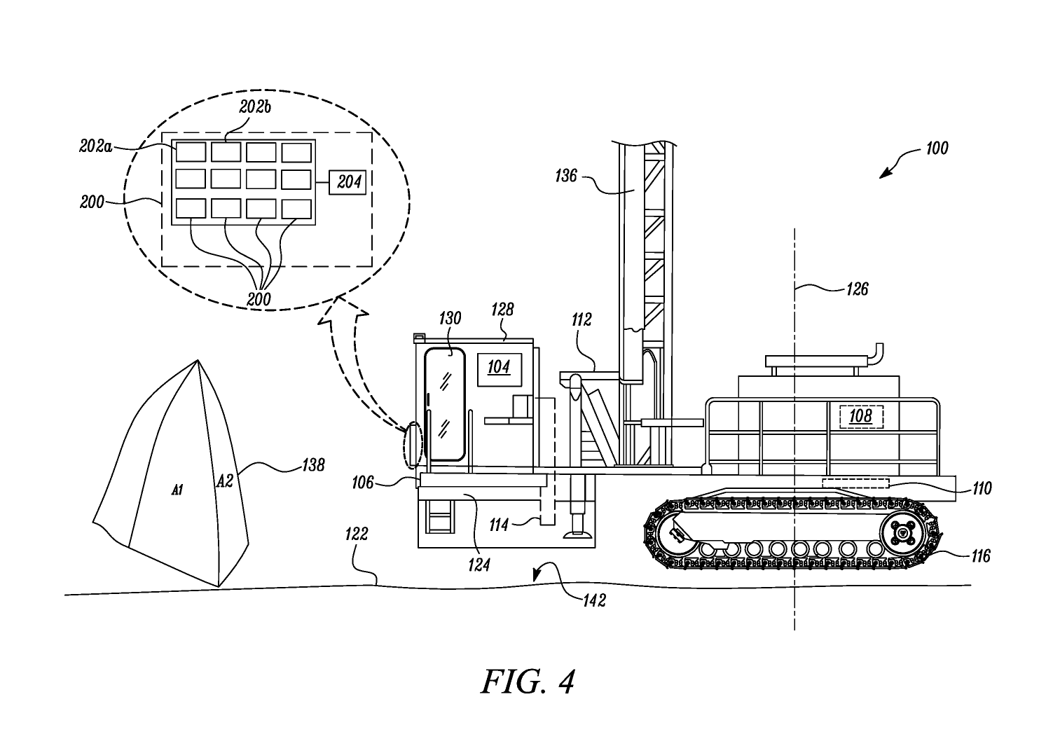

The articulation system 112 may include linkages (not shown) that are coupled to the frame 106 and the work implement 114, as shown in FIGS. 1, 3 and 4. In the embodiment illustrated, the work implement 114 is embodied in the form of a drilling tool. However, in other embodiments, other types of work implements such as, but not limited to, blades, shovels, buckets, scrapers, and the like may be employed by the machine 100 without deviating from the spirit of the present disclosure. Moreover, as the articulation system 112 is operatively driven by the drive system 108, the articulation system 112 can initiate a movement of a drill mast 136 and the work implement 114 relative to the frame 106 of the machine 100 during operation so that the work implement 114 can be operatively raised or lowered relative to the frame 106 for perform functions including, but not limited to, drilling relative to the work surface 122 of the work site 102. Referring to FIG. 3 and FIG. 4, only one side of the machine 100 is illustrated and hence, only one ground engaging member 116 is visible. However, it should be noted that a similar ground engaging member (not shown) is present on the other side of the machine 100 as well. To that end, it must also be noted that the articulation system 112 disclosed herein can further include appropriate systems, mechanisms, and other movement control devices (not shown) that allow a body 124 of the machine 100 to swivel about a swivel axis 126 (refer to FIGS. 1, 3 and 4).

As shown in FIG. 1, FIG. 3 and FIG. 4, the machine 100 may also include a cab 128 having a door 130. The door 130 may be configured to allow access to an operator for entering and exiting the cab 128. As such, the cab 128 could be sized and shaped to house an operator of the machine 100 when operating the machine 100 in a manual or a semi-autonomous mode. However, the present disclosure relates to autonomously controlling movement of the machine 100, and in particular, operating the machine 100 based on various factors as will be described in detail herein.

The machine 100 further includes a control system shown and generally indicated by numeral 200 in FIG. 1. Further explanation pertaining to the control system 200 will now be made in conjunction with FIGS. 2-10.

Referring to FIG. 2, the control system 200 includes a perception system 201. The perception system 201 includes at least one sensor 202, as shown in FIG. 2. In the embodiment illustrated, as shown in FIG. 3-4, the perception system 201 includes at least two sensors 202a, 202b (202a and 202b hereinafter to be referred as ‘first sensor’ and ‘second sensor’ respectively). Although two sensors 202a and 202b are shown in the illustrated embodiment of FIG. 3 and FIG. 4, in other embodiments, the perception system 201 may include more than two sensors 202a to 202n (where n>2). The at least one sensor 202 is configured to generate data signals pertaining to characteristics of an environment 134 associated with the machine 100 (refer to FIG. 1). Further, the at least one sensor 202 may be configured to generate data signals pertaining to the machine 100 and its components. In embodiments herein, the characteristics of the environment 134 associated with the machine 100 include terrain features of the work site 102 and a presence of one or more objects 138 on the work site 102. The one or more objects 138 may include both stationary objects (such as object 138) as well as moving objects (such as 138X and 138Y) located in the vicinity of the machine 100. Data signals pertaining to the one or more objects 138, whether stationary or moving, may be generated by the at least one sensor 202 for subsequently controlling/operating movement of the machine 100 as will be described later herein.

Further, for the purpose of illustration the perception system 201 including the at least one sensor 202 is disposed on the cab 128 of the machine 100. However, in various other embodiments, the perception system 201 inclusive of the at least one sensor 202 may be disposed at any other location of the machine 100.

In an embodiment, the at least one sensor 202 may be one or more perception sensors. As an example, the perception sensor may be one or more devices such as, but not limited to, hall-effect sensors, a light detection and ranging system (LIDAR), a radio detection and ranging system (RADAR), a sound navigation and ranging system (SONAR), one or more visual cameras and the like. One skilled in the art will acknowledge that any type of sensors known in the art may be implemented in lieu of the perception sensor for performing functions that are consistent with the present disclosure.

At least one sensor 202 disclosed herein can obtain data from the environment 134 in which the machine 100 is currently located. In an embodiment, the at least one sensor 202 may generate data signals pertaining to terrain features associated with the work site 102 (refer to FIG. 1). The data signals may be generated by the at least one sensor 202 on the basis of, for example, a contour of the work site 102 e.g., an embankment, a hill, a ridge etc. in which the machine 100 is located. Further, the at least one sensor 202 is also configured to generate data signals pertaining to the one or more objects 138. For example, the at least one sensor 202 may generate data signals pertaining to an overall geometry of the one or more objects 138. Such geometry could include a width, height, and length of the objects; or even a form or contour of the one or more objects 138. The at least one sensor 202 is also configured to generate data signals pertaining to the machine 100 and its components. In an embodiment, the one or more objects 138 may include components of the machine 100 in field of view of the at least one sensor 202.

The at least one sensor 202 could also generate data signals relating to, for example, a current location of the machine 100 and/or a distance of the machine 100 with a respective one of the one or more objects 138 i.e., stationary or moving objects respectively. To that end, the at least one sensor 202 could additionally include other types of devices for e.g., an altimeter for determining other characteristics of the environment 134 for e.g., an altitude of the work surface 122 or the work site 102 on which the machine 100 is located, or an altitude of the work surface 122 or the work site 102 on which the one or more objects 138 are located. Such additional characteristics associated with the environment 134 may be implemented for use in appropriate computations to determine subsequent parameters of interest relating to a positioning of the machine 100, an orientation of the machine 100, and/or a location of the one or more objects 138 on the work site 102 with respect to the machine 100.

As shown in FIGS. 2, 3 and 4, the control system 200 further includes a controller 204. The controller 204 is communicably coupled with the drive system 108, the transmission system 110, the articulation system 112, the work implement 114, and the ground engaging members 116 of the machine 100. In addition, it is also contemplated that in embodiments of the present disclosure, the controller 204 may be further disposed in communication with a steering system 118, and a brake system 120 of the machine 100 as shown in FIG. 2. As such, the steering system 118 disclosed herein is coupled to the ground engaging members 116, and when subject to appropriate commands from the controller 204, can operatively perform a steering of the ground engaging members 116 relative to the frame 106 of the machine 100. Likewise, the brake system 120 is also operatively coupled to the ground engaging members 116, and when subject to appropriate commands from the controller 204, can retard a rotational speed of one or more ground engaging members 116.

The controller 204 is also configured to receive the data signals from the at least one sensor 202. In an embodiment, the controller 204 may be a processor. Based on appropriate computation by the controller 204 the characteristics of the environment 134 can be determined i.e., terrain features associated with the work site 102, and the presence of one or more objects 138 in the vicinity of the machine 100.

In an embodiment, the controller 204 processes the data signals pertaining to the characteristics of the environment 134 and determines the terrain features on the work site 102. For e.g. the controller 204 may be able to determine a depression or a ridge on the work surface 122 of the work site 102. Further, the controller 204 processes the data signals pertaining to the one or more objects 138 and determines the shape and contour of one or more objects 138. Based on the shape and contours of the one or more objects 138, the controller 204 may further classify the one or more objects 138 as a mountain, a large rock, a secondary machine, a personnel, etc. For e.g. the controller 204 may determine the object 138X and the 138Y as a human operator and dump truck respectively. Further, the controller 204 may determine the object 138 in front of the machine 100 as a rock present proximate to the machine 100, as shown in FIG. 1.

The data signals could be provided, in real-time or near real-time, from the at least one sensor 202 to controller 204 for accomplishing a control in the movement of the machine 100 on the work site 102 as will be described later herein.

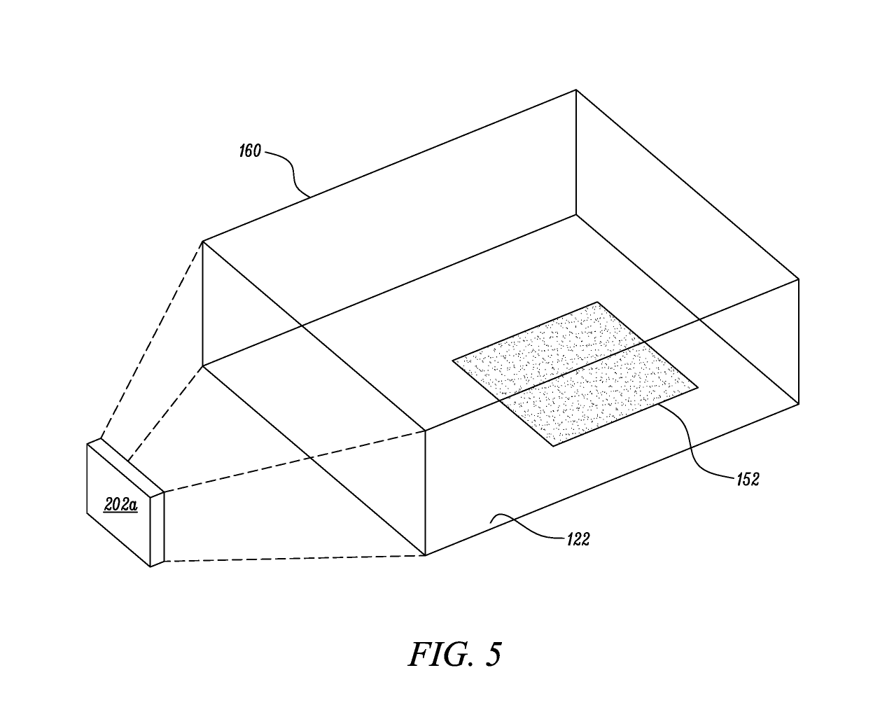

Further, the controller 204 is configured to determine the geometry of the at least one sensor 202. For e.g. the controller 204 may determine the shape and contours of the at least one sensor 202. The controller 204 may also be configured to determine the location of the at least one sensor 202 on the machine 100. The controller 204 then generates a field of view for the at least one sensor 202 for e.g. field of view 160 for the first sensor 202a, as shown in FIG. 5. For the purposes of illustration, the field of view 160 for the first sensor 202a has been denoted by a cuboid encapsulating a portion of the work site 102 wherein the cuboid depicts the 3D representation of the portion of the work site 102.

The process of determining the field of view 160 will now be discussed in detail with reference to FIG. 5. The controller 204 may determine the geometry (shape, contour, length, height) of the first sensor 202a. After computing the geometry of the first sensor 202a, the controller 204 determines the angular range for the first sensor 202a pertaining to which data signals may be generated. After determining the geometry of the first sensor 202a, the controller 204 determines the location and the orientation of the first sensor 202a on the machine 100. Using the location and the orientation of the first sensor 202a along with the angular range of the first sensor 202a, a portion of the work site 102 that would be visible to the first sensor 202a may be determined. The field of view 160 for this portion of the work site 102 is created. However, the controller 204 may not be able to define at least some portion of the work site 102 present within the field of view 160 for the first sensor 202a. This portion of the work site 102 regarding which there is no data has been denoted by the reference numeral 152 and hereinafter shall be referred to as ‘missing data’ (data pertaining to the characteristics of the environment 134 or the machine 100 not perceived by the first sensor 202a). The undefined portion of the work site 102 may be due to an object proximate to the first sensor 202a occluding its field of view or due to harsh environmental conditions on the portion of the work site 102. As used herein, “field of view” may refer to, among other things, the extent of the observable real world that is visible through a sensor at any given moment in time. The field of view may depend on, for example, the particular position and spatial orientation of the sensor, the focal length of the camera lens (which may be variable, in some embodiments), the size of the optical sensor, and/or other factors, at any given time instance.

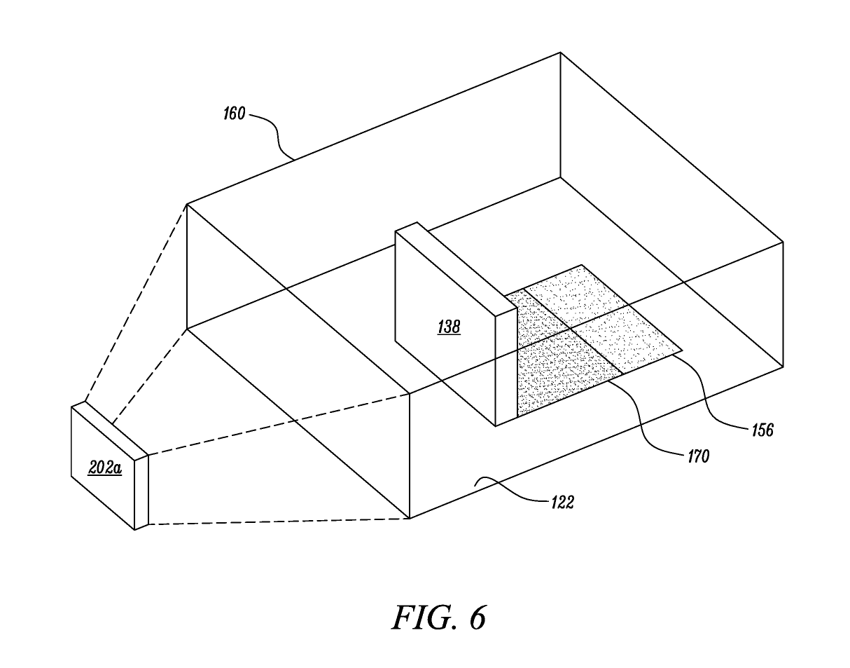

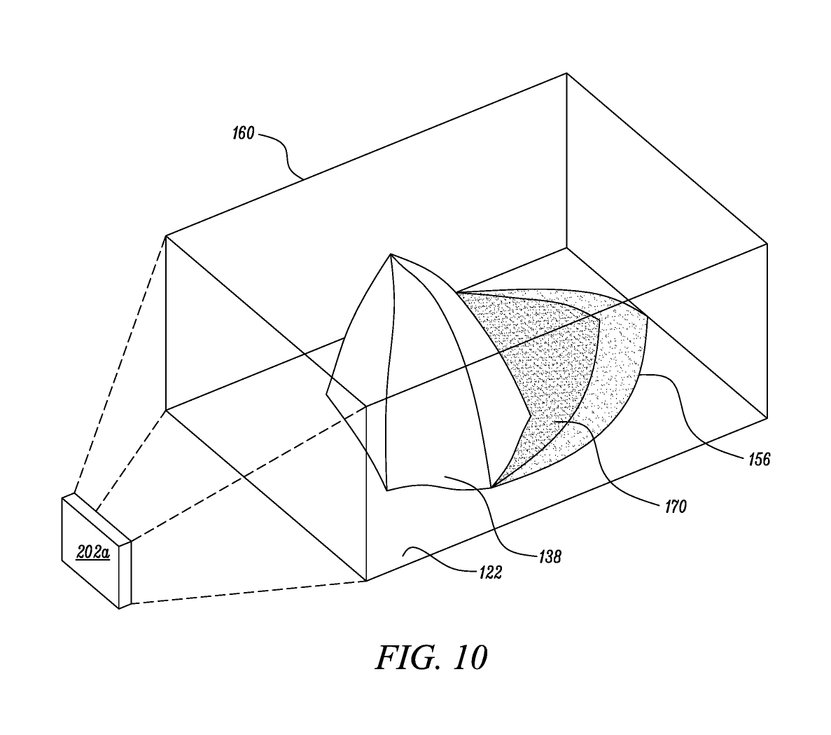

The controller 204 then receives data signals pertaining to one or more objects 138 and/or the machine 100, and determines the shape of the one or more objects 138 and/or the machine 100. Based on the location and geometry of the at least one sensor 202, the controller 204 is configured to estimates cast shadow (the area of the one or more objects 138/the machine 100 that wouldn't be visible to the at least one sensor 202) that would be generated due to the contours of the one or more objects 138. For e.g. as shown in FIG. 6, the controller 204 generates cast shadow 170 for object 138 for the first sensor 202a. The object 138 illustrated in FIG. 6 has been depicted as a cuboid for better understanding of the present disclosure. FIG. 10 depicts the object 138 as the same object depicted in FIG. 1. In various other embodiments, the object 138 may have any kind of shape.

It may be contemplated that for different locations on the worksite or different orientations of the machine 100 with respect to the one or more objects 138, the cast shadow generated by the one or more objects 138 may be different. For e.g. referring to FIG. 3, the machine 100 may be positioned at location 140 on the work site 102. When the machine 100 is at the location 140 on the work site 102, the object 138 may be oriented in such a way that only the area ‘A1’ of the object 138 may be visible to the first sensor 202a. Thus, the cast shadow 170 generated by the object 138 is only due to the area ‘A1’ of the object 138. Further, as illustrated in FIG. 4, for an alternate location 142 of the machine 100 on the work site 102, only the area ‘A2’ of the object 138 may be visible to the first sensor 202a. Thus, the cast shadow 170 generated by the object 138 is only due to the area ‘A2’ of the object 138.

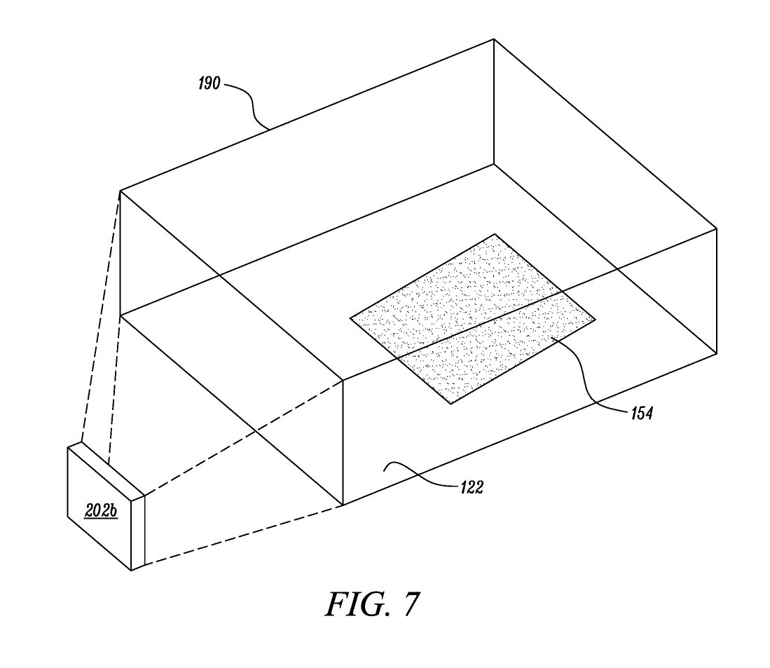

After estimating cast shadow by the one or more objects 138 for the at least one sensor 202, the controller 204 is configured to compare the field of view 160 of the at least one sensor 202 with the cast shadow 170 of the one or more objects 138 for the at least one sensor 202 (as shown in FIG. 7). For e.g. as illustrated in FIG. 7, the controller 204 generates the field of view 160 for the first sensor 202a. The controller 204 then generates the cast shadow 170 of the object 138 for the first sensor 202a and compares the cast shadow 170 with missing data 152 in the field of view 160 for the first sensor 202a. The missing data 152 which does not overlap with the cast shadow 170 of the one or more objects 138 is interpreted as sensor blockage denoted by reference numeral 156 in FIG. 7.

In an embodiment, the controller 204 may estimate field of view of the first sensor 202a for an alternate location 142 on the work site 102 based on the sensor blockage 156 for the first sensor 202a (at the location 140 on the work site 102).

In an embodiment, the controller 204 modifies field of view of the at least one sensor 202 based on sensor blockage and cast shadow of the one or more objects 138. For e.g. as shown in FIG. 6, the field of view 160 of the first sensor 202a has some missing data 152. The controller 204 may modify the missing data 152 to determine that at least a portion of the missing data 152 is because of the cast shadow 170 of the object 138. Further, the controller 204 may also modify the missing data 152 such that the missing data 152 where the cast shadow 170 does not overlap is demarcated as the sensor blockage 156 for the first sensor 202a, as shown in FIG. 7.

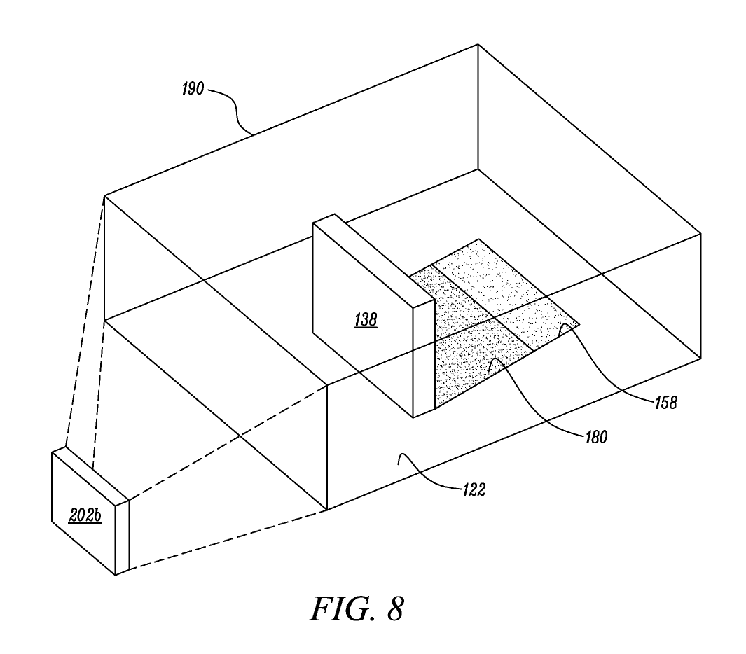

In an embodiment, after determining the sensor blockage 156 for the first sensor 202a (as shown in FIG. 7), the controller 204 is configured to determine a field of view 190 for a second sensor 202b, as shown in FIG. 8. The field of view 190 may have at least some portion relating to which the controller 204 has no data. This unidentified portion in FIG. 8 shall hereinafter be referred to as missing data 180. The controller 204 is then configured to determine sensor blockage 158 for the second sensor 202b and cast shadow 180 due to the object 138, as shown in FIG. 8.

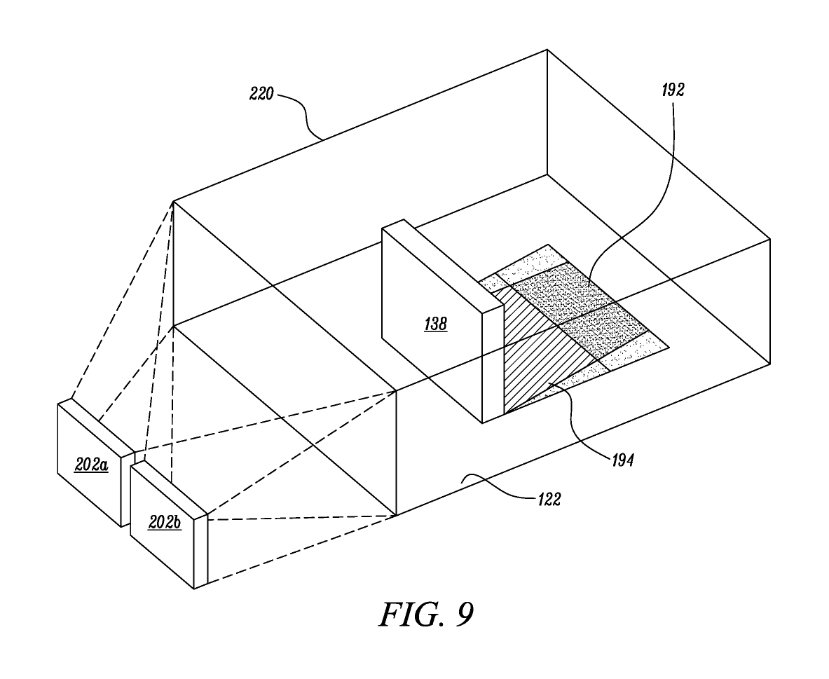

In the embodiment illustrated, the field of view 160 for the first sensor 202a and the field of view 190 for the second sensor 202b encapsulates the same portion of the work site 102. However, in alternate embodiments, the field of view 160 and 190 may encapsulate a different portions of the work site 102. The controller 204 then compares the field of view 160 of the first sensor 202a and a field of view 190 of the second sensor 202b and determines net sensor blockage 192 and net missing data 194 for the first sensor 202a and the second sensor 202b by forming a total cumulative field of view 220 for the perception system 201, as shown in FIG. 9. For e.g. it may be noted that the first sensor 202a may be able to at least partially define the terrain features, one or more objects 138 and the characteristics of the environment 134 around the machine 100 which may lie in missing data 154 and/or sensor blockage 158 (for the second sensor 202b). Similarly, second sensor 202b may be able to define at least partially the terrain features, one or more objects 138 and the characteristics of the environment 134 around the machine 100 that may lie in the missing data 152 and/or sensor blockage 156 for (the first sensor 202a). The controller 204 may accordingly determine the net sensor blockage 192 and the net missing data 194 by removing the portion of the missing data 152 and/or sensor blockage 156 visible to the second sensor 202b and the portion of the missing data 154 and/or sensor blockage 158 visible to the first sensor 202a. Thus, the net sensor blockage 192 (the dark dotted portion) may be defined as the overlap of the sensor blockage 156 and the sensor blockage 158. Similarly, the net missing data 194 (the angularly lined portion) may be defined as the overlap of the missing data 152 and 154.

Based on the calculated net sensor blockage 192 and the net missing data 194 for the first sensor 202a and the second sensor 202b, the controller 204 determines the blind zone for the machine 100. The blind zone may be defined as at least a portion of the work site 102 not visible to both the first sensor 202a and the second sensor 202b. The net sensor blockage 192 and the net missing data 194 for the first sensor 202a and the second sensor 202b include the portion of the work site 102 not visible to both the first sensor 202a and the second sensor 202b. Accordingly, the net sensor blockage 192 and the net missing data 194 for the first sensor 202a and the second sensor 202b become the blind zone for the machine 100.

In an embodiment, the controller 204 may determine only the net sensor blockage 192. For e.g. the controller 204 may be able to determine the one or more objects 138, the characteristics of the environment 134 and the terrain features in the net missing data 194. However, the controller 204 may not be able to determine the one or more objects 138, the characteristics of the environment 134 and the terrain features in the net sensor blockage 192. Thus, only the net sensor blockage 192 becomes the portion of the work site 102 not visible to both the first sensor 202a and the second sensor 202b. Accordingly, the blind zone will only be the net sensor blockage 192.

Further, the controller 204 may be configured to determine whether the one or more objects 138 have moved in or are in the blind zone for the machine 100 based on the location of the machine 100. For e.g. after determining the blind zone, the machine 100 may have to move to another location (from location 140 to location 142). Based on the location of the machine 100, the controller 204 detects the one or more objects 138 that should be lying in the blind zone for the machine 100 (due to the change in location of the machine 100). Thus, we can determine whether the one or more objects 138 and a portion of the terrain of the work site 102 are lying in the blind zone of the machine 100 i.e. are not visible to the at least one sensor 202 due to the blind zone for the machine 100.

In an alternate embodiment, the perception system 201 may be configured to continuously collect data signals pertaining to the one or more objects 138 on the work site 102. The controller 204 may be configured to receive these data signals pertaining to the one or more objects 138 and detect whether the one or more objects 138 have moved from one location to another location on the work site 102. For e.g. the perception system 201 uses the at least one sensor 202 to gather data signals pertaining to the one or more objects 138X and 138Y on the work site 102 at different time intervals. The controller 204 then receives the data signals pertaining to the one or more objects 138X and 138Y at different time intervals and applies certain algorithms to the data signals to determine the location of the one or more objects 138X and 138Y at different time intervals. If the location of the one or more objects 138X and 138Y changes at different time intervals then the controller 204 concludes that the one or more objects 138X and 138Y are moving objects.

In an alternate embodiment, the machine 100 may have to move to a plurality of planned positions on the work site 102. However, as discussed above, the one or more objects 138 may have been detected as being moving objects. After determining that the one or more objects 138 are moving objects, the controller 204 determines the end location of the moving objects to determine whether the one or more objects 138 have moved into the blind zone for the machine 100 at the plurality of positions on the work site 102.

Further, the controller 204 may be configured to determine one or more locations of the machine on the work site 102 when the one or more objects 138 may be occluded from the field of view of the at least one sensor 202. For e.g. during operation, the machine 100 may have to move from one location to another location (from location 140 to location 142 on the work site 102). The controller 204 may have determined the sensor blockage for the at least one sensor 202. Further, during operation the controller 204 may have determined the location of the one or more objects 138 on the work site 102. The controller 204 determines whether the sensor blockage for the at least one sensor 202 is obstructing a portion of the field of view for the at least one sensor 202 wherefrom the one or more objects 138 would have been visible.

The controller 204 may also be configured to actuate movement of the machine 100 based on the sensor blockage and the blind zones for the at least one sensor 202. The controller 204 may also be configured with appropriate set/s of capabilities for interpreting the presence of the one or more objects 138 as ‘obstacles’ with regards to determining a path of travel for the machine 100 by the controller 204 on the basis of the determined characteristics of the environment 134. In such embodiments, the controller 204 is further configured to determine a path of travel for the machine 100 on the basis of the detected obstacles, as represented by the one or more objects 138 present in the vicinity of the machine 100. For example, the at least one sensor 202 may generate data signals indicative of a detection of a tree on the work site 102. Based on inputs from the perception system 201 the controller 204 may correspondingly navigate the machine 100 by appropriately commanding the drive system 108, the steering system 118, the braking system, and the articulation system 112 so that the machine 100 is avoided from coming into contact or colliding with the tree on the work site 102.

### INDUSTRIAL APPLICABILITY

Autonomous machines are designed to perform some or all required functions autonomously (using sensors), i.e., without contemporaneous user input, the systems and methods used to control the autonomous machines are highly dependent on the area of a work site that can be perceived by the sensor of the autonomous machine. The machine's ability to perceive its environment is constrained by the sensors field of view and sensing range, the terrain complexity arising from static and dynamic objects and atmospheric conditions (dust, rain). Accordingly, large sections of the terrain might not be visible to the machine.

In an aspect of the present disclosure, a control system 200 for a machine is disclosed. The control system comprises a perception system 201 comprising at least one sensor 202 and a controller 204. The perception system 201 uses the at least one sensor 202 and gathers data signals pertaining to the characteristics of the environment 134. The controller 204 receives the data signals pertaining to the environment 134.

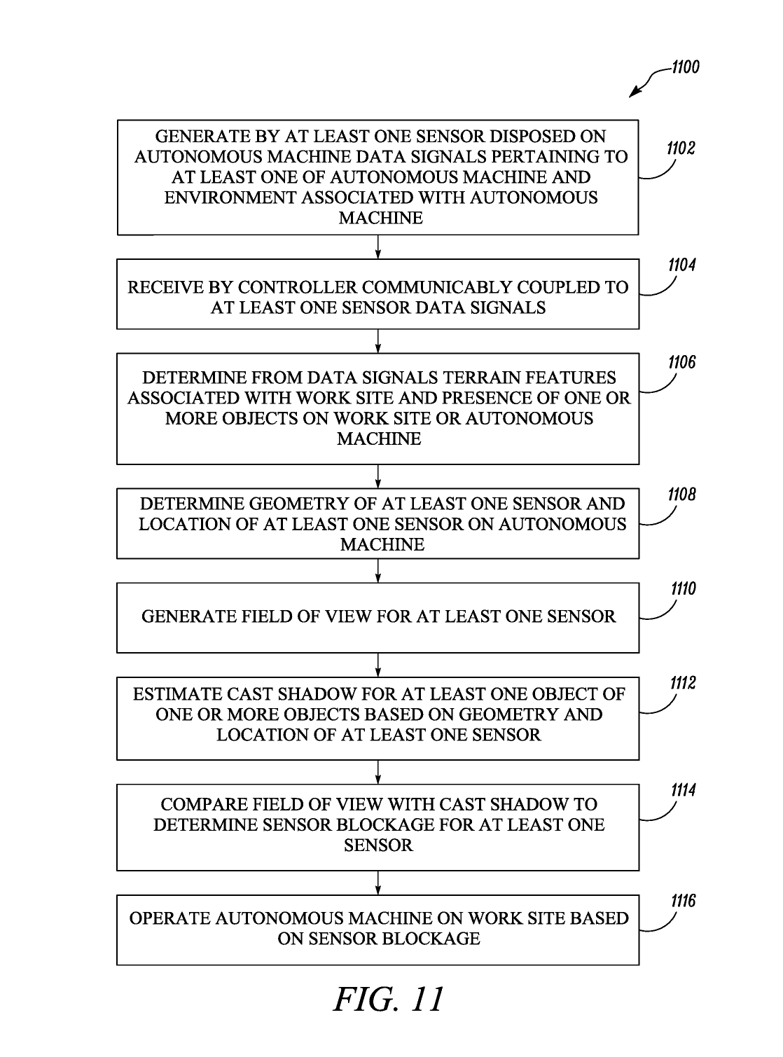

In an aspect of the present disclosure, a method 1100 for controlling an operation of a machine for e.g., the machine 100, is disclosed, as shown in FIG. 11. The method will be described with reference to FIGS. 2, 3, 5 and 6. The method 1100 includes generating data signals pertaining to at least one of the machine 100 and the environment 134 associated with the machine 100 using the first sensor 202a of the perception system 201 on the machine 100 (step 1102). Then the controller 204 receives the data signals from the first sensor 202a (step 1104). The controller 204 then determines from the data signals terrain features associated with the work site 102 and presence of one or more objects 138 on the work site 102 or the machine 100 (step 1106). Further, the controller 204 determines the geometry of the first sensor 202a and location of the first sensor 202a on the machine 100 (step 1108). Further, the controller 204 generates the field of view 160 for the first sensor 202a (step 1110). The controller 204 then estimates the cast shadow 170 for at least one object of the one or more objects 138 based on the geometry and location of the first sensor 202a (step 1112). The controller 204 further compares the field of view 160 with the cast shadow 170 to determine the sensor blockage for the at least one sensor 202 (step 1114). Based on the sensor blockage the controller 204 operates the machine 100 on the work site 102 to steer the vehicle safely (step 1116). Thus, the control system 200 of the present disclosure helps in safely steering the machine 100 on the work site 102 by establishing the sensor blockage 156 (area not visible to the at least one sensor 202). This helps avoid hazardous accidents and accidental damage to the machine 100.

Further, with implementation of embodiments disclosed herein, several machines known to persons skilled in the art can be beneficially rendered autonomous with regards to the functions required on a given work site. With regards to the drilling industry, use of embodiments disclosed herein can assist many vendors to entail reduced costs, at least in part, due to the autonomous operation of drilling machines on a given work site.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A control system for a machine operating at a work site, the control system comprising:
a perception system comprising at least one sensor disposed on the machine and configured to generate data signals pertaining to at least one of:
the machine; and
an environment associated with the machine;
a controller communicably coupled to the perception system for receiving the data signals from the at least one sensor and configured to:
determine from the data signals terrain features associated with the work site and presence of one or more objects on the work site or the machine;
determine geometry of the at least one sensor, location of the at least one sensor on the machine and generate a field of view for the at least one sensor;
estimate cast shadow for at least one object of the one or more objects based on the geometry of the at least one sensor and location of the at least one sensor; and
compare the field of view with the cast shadow to determine sensor blockage for the at least one sensor.

2. The control system of claim 1 wherein the controller is configured to determine expected field of view for the at least one sensor based on the sensor blockage and the location of the machine on the work site.

3. The control system of claim 1 wherein the controller is configured to determine the sensor blockage for at least two sensors.

4. The control system of claim 3 wherein the controller is configured to determine a blind zone for the machine based on the sensor blockage of the at least two sensors.

5. The control system of claim 4 wherein the controller is configured to determine if the one or more objects on the work site have moved or are in the blind zone based on the location of the machine.

6. The control system of claim 1 wherein the controller is configured to modify the generated field of view of the at least one sensor based on the sensor blockage and the presence of the one or more objects.

7. The control system of claim 1 wherein the controller is configured to determine one or more locations of the machine on the work site when the one or more objects may be occluded from the field of view of the at least one sensor.

8. A machine comprising:
a frame;
at least one operational system disposed on the frame, the at least one operational system being configured to actuate at least one type of operation in the machine;
a perception system comprising at least one sensor disposed on the machine and configured to generate data signals pertaining to at least one of:
the machine; and
an environment associated with the machine;
a controller communicably coupled to the perception system for receiving the data signals from the at least one sensor and configured to:
determine from the data signals terrain features associated with a work site and presence of one or more objects on the work site or the machine;
determine geometry of the at least one sensor, location of the at least one sensor on the machine and generate a field of view for the at least one sensor;
estimate cast shadow for at least one object of the one or more objects based on the geometry of the at least one sensor and location of the at least one sensor; and
compare the field of view with the cast shadow to determine sensor blockage for the at least one sensor.

9. The machine of claim 8 wherein the controller is configured to determine expected field of view for the at least one sensor based on the sensor blockage and the location of the machine on the work site.

10. The machine of claim 8 wherein the controller is configured to determine the sensor blockage for at least two sensors.

11. The machine of claim 10 wherein the controller is configured to determine a blind zone for the machine based on the sensor blockage of the at least two sensors.

12. The machine of claim 11 wherein the controller is configured to determine if the one or more objects on the work site have moved or are in the blind zone based on the location of the machine.

13. The machine of claim 8 wherein the controller is configured to modify the generated field of view of the at least one sensor based on the sensor blockage and the presence of the one or more objects.

14. The machine of claim 8 wherein the controller is configured to determine one or more locations of the machine on the work site when the one or more objects may be occluded from the field of view of the at least one sensor.

15. A method of operating an autonomous machine on a work site, the method comprising:
generating by at least one sensor disposed on the autonomous machine data signals pertaining to at least one of the autonomous machine and an environment associated with the autonomous machine;
receiving by a controller communicably coupled to the at least one sensor the data signals;
determining from the data signals terrain features associated with the work site and presence of one or more objects on the work site or the autonomous machine;
determining geometry of the at least one sensor and location of the at least one sensor on the autonomous machine;
generating a field of view for the at least one sensor;
estimating cast shadow for at least one object of the one or more objects based on the geometry and the location of the at least one sensor;
comparing the field of view with the cast shadow to determine sensor blockage for the at least one sensor; and
operating the autonomous machine on the work site based on the sensor blockage.

16. The method of claim 15 further comprising determining by the controller expected field of view for the at least one sensor based on the sensor blockage and the location of the autonomous machine on the work site.

17. The method of claim 15 further comprising determining by the controller the sensor blockage for at least two sensors.

18. The method of claim 17 further comprising determining by the controller a blind zone for the autonomous machine based on the sensor blockage of the at least two sensors.

19. The method of claim 18 further comprising determining by the controller if the one or more objects on the work site have moved or are in the blind zone based on the location of the autonomous machine.

20. The method of claim 15 further comprising modifying by the controller the generated field of view of the at least one sensor based on the sensor blockage and the presence of the one or more objects.
